(19) United States
(12) Patent Application Publication
(10) Pub. No.: US 2026/0229556 A1
(43) Pub. Date: Aug. 6, 2026

(54) FUEL CELL

(71) Applicant: HITACHI HIGH-TECH CORPORATION, Minato-ku, Tokyo (JP)

(72) Inventors: Ryuusei FUJITA, Tokyo (JP); Yoshitaka SASAGO, Tokyo (JP); Noriyuki SAKUMA, Tokyo (JP); Natsuki YOKOYAMA, Tokyo (JP); Hiroyuki UCHIYAMA, Tokyo (JP); Masakazu SAGAWA, Tokyo (JP); Nobuyuki MISE, Tokyo (JP); Aritoshi SUGIMOTO, Tokyo (JP)

(21) Appl. No.: 19/160,275

(22) PCT Filed: May 26, 2023
(86) PCT No.: PCT/JP2023/019771

§ 371 Date: Aug. 27, 2025

(51) Int. Cl. H01M 8/0258; H01M 8/023; H01M 8/0271

(52) U.S. Cl. CPC H01M 8/0258; H01M 8/023; H01M 8/0271

(57) ABSTRACT

The present invention provides a fuel cell that can secure an effective area of the fuel cell while suppressing a parasitic resistance of the fuel cell. In the fuel cell according to the present invention, a conductive substrate is disposed so as to contact a porous support layer at a location where a through-hole is not formed, and a structure allowing gas to flow in a direction orthogonal to an extending direction of the through-hole is formed at an interface between the conductive substrate and the porous support layer at the location (see FIG. 1).

### TECHNICAL FIELD

The present invention relates to a fuel cell.

### BACKGROUND ART

Fuel cells using fuel such as hydrogen have recently been attracting attention as a power generation system without emitting carbon dioxide. A fuel cell has a structure with an electrolyte sandwiched between two electrodes, an anode and a cathode, and performs power generating operation by supplying a fuel gas such as hydrogen to the anode side and a gas containing oxygen such as air to the cathode side. The fuel cell disclosed in Patent Literature 1 is formed by stacking an electrode layer/electrolyte layer/electrode layer in this order on a metal support frame.

### CITATION LIST

### Patent Literature

Patent Literature 1: US 20220271317 A1

### SUMMARY OF INVENTION

### Technical Problem

The metal support frame of Patent Literature 1 is divided into a dense region and a porous region, and the porous region has through-holes having a diameter of 10 to 150 μm for supplying gas to the electrode layer immediately above. A fuel cell having a thinner electrolyte layer can generate more electric power, but since the fuel cell does not operate without the through-holes being sealed, when the through-hole diameter is 10 μm or greater, it is difficult to form a thin electrolyte layer having a thickness of, for example, 1 μm or smaller.

In order to form a thin electrolyte layer having a thickness of 1 μm or smaller, it is desirable to use a substrate having through-holes with a diameter of 300 nm or smaller. For example, Anodic Aluminum Oxide (AAO) allows the diameter of the through-holes to be 300 nm or smaller, and using this as the porous support layer and by staking thereon the electrode layer/electrolyte layer/electrode layer in this order, a thin-film fuel cell can be formed. It is conceived that Anodic Aluminum Oxide is an insulating material, but can extract generated power to the outside by being placed on a conductive substrate such as a metal support frame, with the front and back electrically connected with a metal film formed on the inner wall of the through-holes. In this case, however, some of the through-holes in the porous support layer are sealed by the conductive substrate, which reduces the effective area of the fuel cell. For example, the metal support frame of Patent Literature 1 has a maximum porosity of 60%, and thus, when a thin-film cell using a porous support layer is disposed thereon, the effective area is reduced by 40%.

In place of using the through-holes in the porous support layer, for example, with a portion of a lower electrode exposed on the front side so as to arrange a conductive portion, the generated power of the fuel cell can be extracted without sealing the through-holes in the porous support layer. However, such a conductive path generates power loss due to the sheet resistance of the lower electrode, which obstructs increasing the area of the fuel cell.

The present invention has been made in view of the aforementioned problems, and has an object of providing a fuel cell that can secure an effective area of the fuel cell while suppressing a parasitic resistance of the fuel cell.

### Solution to Problem

In the fuel cell according to the present invention, a conductive substrate is disposed so as to contact a porous support layer at a location where a through-hole is not formed, and a structure is formed at an interface between the conductive substrate and the porous support layer at the location, the structure allowing gas to flow in a direction orthogonal to an extending direction of the through-hole.

### Advantageous Effects of Invention

In the fuel cell according to the present invention, an effective area of the fuel cell can be secured while suppressing a parasitic resistance of the fuel cell. Problems, configurations and advantageous effects other than those described above will become apparent from the following description of embodiments.

### BRIEF DESCRIPTION OF DRAWINGS

FIG. 1 is a cross-sectional view showing the structure of a fuel cell 1 according to Embodiment 1.

FIG. 2 is an enlarged cross-sectional view of a porous support layer 4.

FIG. 3A is an enlarged perspective view of a surface of a conductive substrate 2.

FIG. 3B is a further enlarged view of the vicinity of a surface flow path 10 of FIG. 3A.

FIG. 4A is a cross-sectional view showing a current path.

FIG. 4B is a cross-sectional view showing the current path when the porous support layer 4 is an insulating material.

FIG. 5A is a cross-sectional view showing an example of the structure of a fuel cell stack 500.

FIG. 5B is an exploded view of layers of the fuel cell stack 500.

FIG. 6 is a cross-sectional view showing an example of the structure of a fuel cell stack 600 according to Embodiment 2.

FIG. 7 is a cross-sectional view showing an example of the structure of the fuel cell 1 according to Embodiment 3.

FIG. 8 is a cross-sectional view showing an example of the structure of the fuel cell 1 according to Embodiment 4.

FIG. 9A is a view for explaining the definition of the depth of the surface flow path 10.

FIG. 9B is a view for explaining the definition of the depth of the surface flow path 10.

FIG. 10 is a cross-sectional view showing an example of the structure of a fuel cell 1000 according to Embodiment 5.

FIG. 11 is a cross-sectional view showing an example of the structure of the fuel cell 1 according to Embodiment 6.

FIG. 12 is a cross-sectional view showing an example of the structure of the fuel cell 1 according to Embodiment 7.

FIG. 13 is a cross-sectional view showing an example of the structure of the fuel cell 1 according to Embodiment 8.

FIG. 14 is a cross-sectional view showing an example of the structure of the fuel cell 1 according to Embodiment 9.

FIG. 15 is a cross-sectional view showing an example of the structure of the fuel cell 1 according to Embodiment 10.

FIG. 16 is a cross-sectional view showing an example of the structure of the fuel cell 1 according to Embodiment 11.

FIG. 17 is a cross-sectional view showing an example of the structure of the fuel cell 1 according to Embodiment 12.

FIG. 18 is a cross-sectional view showing an example of the structure of the fuel cell 1 according to Embodiment 13.

### DESCRIPTION OF EMBODIMENTS

### Embodiment 1

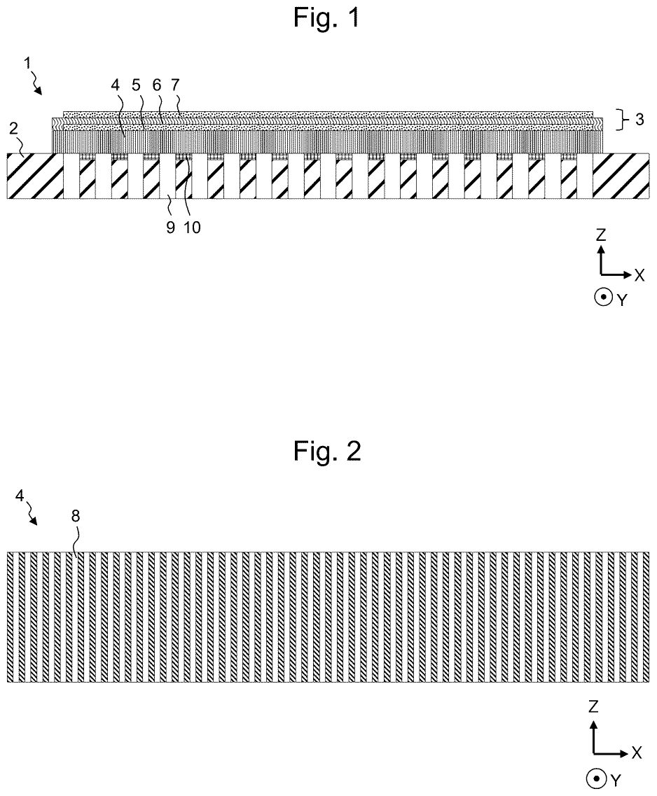

FIG. 1 is a cross-sectional view showing the structure of a fuel cell 1 according to Embodiment 1 of the present invention. The fuel cell 1 has at least one unit cell 3 (hereinafter, also simply referred to as a cell) mounted on a conductive substrate 2.

The unit cell 3 is a fuel cell composed of a porous support layer 4, a first electrode layer 5, an electrolyte layer 6 (solid electrolyte layer), and a second electrode layer 7, and the electrolyte layer 6 is sandwiched between the first electrode layer 5 and the second electrode layer 7.

When the first electrode layer 5, the electrolyte layer 6, and the second electrode layer 7 are made as thin films having a thickness of, for example, 1 μm or smaller for the purpose of manufacturing a high power density cell, the porous support layer 4 serves to support the entire unit cell 3. The porous support layer 4 has a porous structure having second through-holes 8 in a Z-direction as shown in FIG. 2 which will be described later, thereby allowing gas to reach the first electrode layer 5. The Z-direction is a direction from the bottom surface of the conductive substrate 2 toward the surface of the second electrode layer 7. A plane having the Z-direction as its normal direction is defined as an X-Y plane, a direction perpendicular to the Z-direction is defined as an X-direction, and a direction perpendicular to both the Z-direction and the X-direction is defined as a Y-direction.

The first electrode layer 5 is formed by a film forming process such as sputtering, but the first electrode layer 5 is not formed on the entire surface of the porous support layer 4 and a region where the first electrode layer 5 is not formed is provided on an outer periphery of the porous support layer 4. This is because the first electrode layer 5 is in a porous structure for supplying gas to the electrolyte layer 6, and thus, in a case where the first electrode layer 5 is formed on the entire surface of the porous support layer 4, gas leakage could occur between the top and bottom of the unit cell 3. The gas leakage can be prevented by leaving the outer periphery of the porous support layer 4 and covering it with the electrolyte layer 6 in a dense structure.

When the first electrode layer 5 is made to function as an anode of the fuel cell, a fuel gas such as hydrogen is supplied to the first electrode layer 5. In that case, the first electrode layer 5 is composed of material such as a cermet of nickel and yttria-stabilized zirconia. The electrolyte layer 6 is composed of material such as stabilized zirconia with a composition ratio of yttria of 8%. When the electrolyte layer 6 is made into a thin film of 1 μm or smaller by a film forming process such as sputtering, power generation with a high power density is also attainable. When the first electrode layer 5 is the anode, the second electrode layer 7 is the cathode and is composed of material such as platinum and a cermet of platinum and GDC (gadolinium doped ceria), or LSC ((La, Sr)CoO₃), and has a porous structure to allow an oxidant gas to reach the electrolyte layer 6. Alternatively, when the second electrode layer 7 is material having both oxygen ion (O²⁻) and electron conductivities, the porous structure is not necessarily required. When the first electrode layer 5 serves as the cathode and the second electrode layer 7 serves as the anode, an oxidant gas is supplied to the first electrode layer 5 and a fuel gas is supplied to the second electrode layer 7.

The conductive substrate 2 is a conductor and is desirably composed of material such as a stainless steel alloy having a certain degree of mechanical strength even at high temperatures. Further, material having a thermal expansion coefficient close to that of the porous support layer 4 is desirable. For example, when the porous support layer 4 is an aluminum oxide, the thermal expansion coefficient of the conductive substrate 2 is desirably 10×10⁻⁶/K (linear expansion coefficient) or smaller, more ideally around 7 to 8×10⁻⁶/K (linear expansion coefficient).

The conductive substrate 2 is provided with first through-holes 9 that are formed using a laser machining technique or the like. The area of the first through-hole 9 is larger than that of the second through-hole 8 of the porous support layer 4, and can be as large as 100 times or more. The distance between the first through-holes 9 is almost the same as the width of each first through-hole 9 of the conductive substrate, and can be 100 or more times larger as compared to the width of the second through-hole 8. Therefore, on a surface where the conductive substrate 2 and the porous support layer 4 contact with each other, multiple through-holes 8 of the porous support layer 4 are arranged between the first through-holes 9 of the conductive substrate 2.

The conductive substrate 2 has surface flow paths 10 (structure that allows gas to flow in a direction orthogonal to an extending direction of the second through-holes 8) on its surface. The detailed structure of the surface flow path 10 will be described later. With the surface flow paths 10, the gas supplied through the first through-holes 9 of the conductive substrate 2 is supplied via the surface flow paths 10 to the second through-holes 8 of the porous support layer 4, and is further supplied to the first electrode layer 5.

In a structure without the surface flow paths 10 as in conventional techniques, at portions where the first through-holes 9 are not formed in the site where the conductive substrate 2 and the porous support layer 4 contact with each other, the second through-holes 8 are sealed. In that case, gas does not flow through the portions, which could reduce the effective area contributing to power generation of the surface area of the unit cell 3. In contrast, with the surface flow paths 10 provided on the surface of the conductive substrate 2, the gas is supplied to the second through-holes 8 also at positions where the first through-holes 9 are not formed. However, the surface flow path 10 is not provided at an end position of the unit cell 3. This is for preventing a fuel gas and an oxidant gas from mixing via the surface flow path 10.

FIG. 2 is an enlarged cross-sectional view of the porous support layer 4. The porous support layer 4 has a plurality of second through-holes 8 extending therethrough in the Z-direction. The hole diameter of each second through-hole 8 is desirably 300 nm or smaller. This is because when the hole diameter is too large, the thickness of the layer formed above the second through-holes 8 needs to be correspondingly increased in order to seal the second through-holes 8.

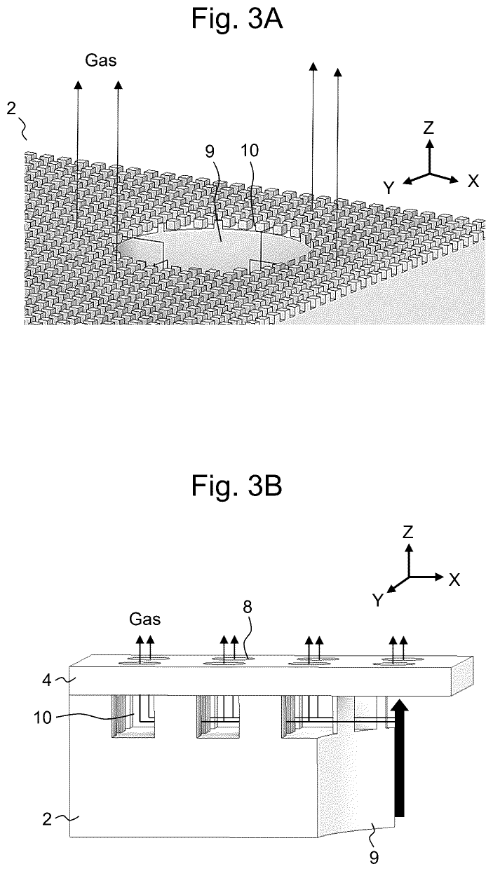

FIG. 3A is an enlarged perspective view of the surface of the conductive substrate 2. FIG. 3B is a further enlarged view of the vicinity of the surface flow path 10. Part of the gas that has reached the surface of the conductive substrate 2 through the first through-holes 9 enters the surface flow paths 10 and advances in the X-direction and Y-direction. Since the porous support layer 4 is present immediately above the conductive substrate 2 as shown in FIG. 3B, the gas enters the second through-holes 8 of the porous support layer 4 and advances in the Z-direction toward the first electrode layer 5. Although FIG. 3A shows only four gas passages, the gas actually diffuses in all directions, branches midway in the X-direction and Y-direction, and spreads over the entire surface of the conductive substrate 2. Since minute spaces in the surface flow paths 10 are all filled with the gas, a concentration gradient occurs due to a decrease in concentration as the gas is consumed during the power generating operation, and the gas is supplied from a side with a higher concentration (the bottom of the first through-holes 9). Gas does not move from a site with a lower concentration to a site with a higher concentration, and the gas movement in the X-and Y-directions in the surface flow paths 10 al so does not contradict this principle. In FIG. 3B, branching only in the X-direction and Z-direction is shown for simplicity, but branching may actually be in all the X-, Y-, and Z-directions.

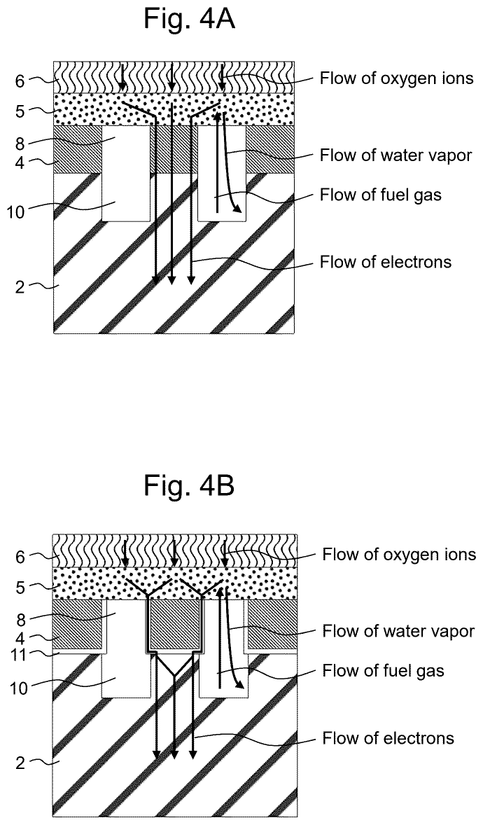

FIG. 4A is a cross-sectional view showing a current path. As an example, a case in which the first electrode layer 5 is used as an anode is shown. In FIG. 4A, the porous support layer 4 is a conductive material. The fuel gas passes, via the surface flow paths 10 of the conductive substrate 2 and the second through-holes 8 of the porous support layer 4, through the first electrode layer 5 in a porous structure, and reacts, at an interface with the electrolyte layer 6, with oxygen ions that have moved through the electrolyte layer 6 so as to generate water vapor and electrons. The water vapor is discharged to the outside via the second through-holes 8, the surface flow paths 10, and the first through-holes 9 (not shown). The electrons are extracted from the first electrode layer 5 via the porous support layer 4 and the conductive substrate 2 to the outside and are delivered to a load that consumes power.

FIG. 4B is a cross-sectional view showing a current path in a case where the porous support layer 4 is an insulating material. When the porous support layer 4 is an insulating material, electrical connection from the front surface to the back surface of the porous support layer 4 is necessary, and this is achieved by, for example, providing through-hole inner wiring 11 inside the second through-holes 8. The flows of gas and oxygen ions are the same as those in FIG. 4A, but because the porous support layer 4 is an insulating material, the electrons generated at the interface between the first electrode layer 5 and the electrolyte layer 6 flow toward the through-hole inner wiring 11 and are extracted to the outside via the through-hole inner wiring 11 and the conductive substrate 2. When the through-hole inner wiring 11 is formed so as to continue to the back surface of the porous support layer 4 as shown in FIG. 4B, the electrical connection between the through-hole inner wiring 11 and the conductive substrate 2 can be secured.

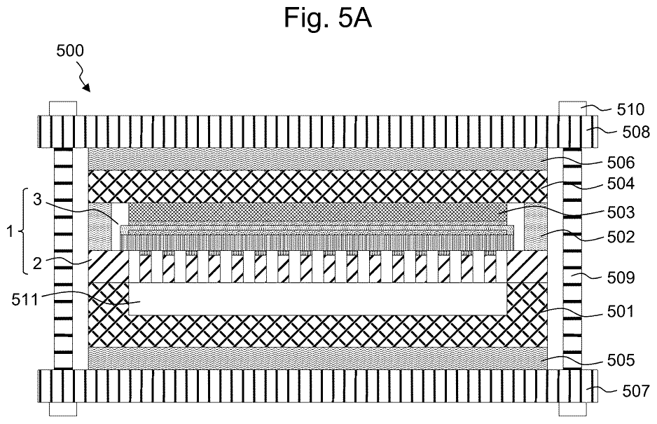

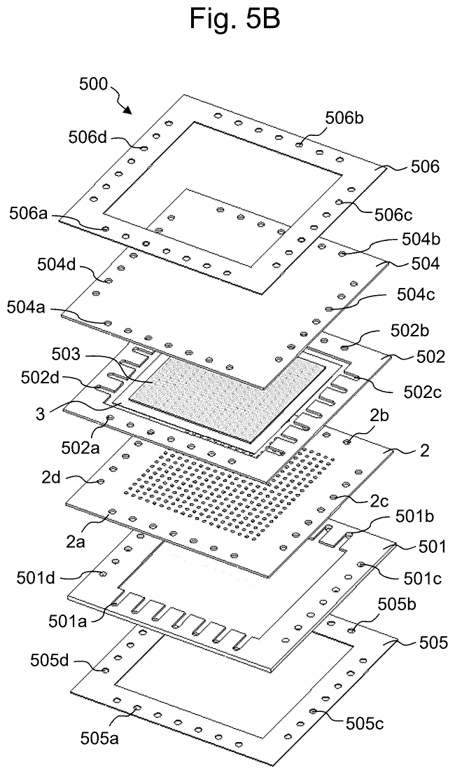

FIG. 5A is a cross-sectional view showing an example of the structure of a fuel cell stack 500. The fuel cell stack 500 includes a fuel cell 1, a separator 501, a cell portion gasket 502, a current collector 503, an upper electrode plate 504, a lower gasket 505, an upper gasket 506, a bottom jig 507, a top jig 508, supports 509, and fastening members 510. The fuel cell stack 500 is assembled by stacking the bottom jig 507, the lower gasket 505, the separator 501, the fuel cell 1, the upper electrode plate 504, the upper gasket 506, and the top jig 508 in this order from the bottom. Holes through which the supports 509 pass are drilled in the bottom jig 507 and the top jig 508, and both ends of the supports 509 are machined so as to follow the shape of the fastening members 510, and for example, when the fastening members 510 are nuts, threads having the same shape as that of the fastening members 510 are provided in the supports 509, and the fuel cell stack 500 is entirely fastened from above and below by fastening the fastening members 510.

This structure can prevent the fuel gas and the oxidant gas used for operation of the fuel cell 1 from leaking out of the fuel cell stack 500. The separator 501 and the conductive substrate 2 are joined by welding or the like so that the gasses are prevented from leaking out and the separator 501 is electrically connected to the first electrode layer 5 of the fuel cell 1. At this time, by forming the separator 501 in a shape having a recess inside while leaving the ends, a gas flow path 511 that can supply gas to the first through-holes 9 of the conductive substrate 2 is formed. Further, since the upper electrode plate 504 is electrically connected to the second electrode layer 7 via the current collector 503, the power generated by the fuel cell 1 can be extracted to the outside.

FIG. 5B is an exploded view of the layers of the fuel cell stack 500. The conductive substrate 2 has a first gas inlet 2a, a first gas outlet 2b, a second gas inlet 2c, and a second gas outlet 2d. A first gas is a fuel gas or an oxidant gas, and a second gas is an oxidant gas when the first gas is a fuel gas or is a fuel gas when the first gas is an oxidant gas.

As with the conductive substrate 2, (a) the separator 501 has a first gas inlet 501a, a first gas outlet 501b, a second gas inlet 2c, and a second gas outlet 501d, (b) the cell portion gasket 502 has a first gas inlet 502a, a first gas outlet 502b, a second gas inlet 502c, and a second gas outlet 502d, and (c) the upper electrode plate 504 has a first gas inlet 504a, a first gas outlet 504b, a second gas inlet 504c, and a second gas outlet 504d.

By providing a first gas inlet 505a or 506a, a first gas outlet 505b or 506b, a second gas inlet 505c or 506c, and a second gas outlet 505d or 506d in at least one of the lower gasket 505 and the upper gasket 506, the first gas and the second gas can be supplied to the unit cell 3 from the bottom jig 507 or the top jig 508. The gasses can also be supplied from both the bottom jig 507 and the top jig 508. In the example of FIG. 5B, a configuration example of all the layers having inlets and outlets on the four sides is shown. In the following example, a case will be described in which the first gas is supplied through the first gas inlet 505a of the lower gasket and the second gas is supplied through the second gas inlet 506c of the upper gasket.

The first gas supplied through the first gas inlet 505a of the lower gasket flows into the first gas inlet 501a of the separator. Since the first gas inlet 501a of the separator has a cut-out, the first gas moves toward the first gas outlet 501b while passing over the separator 501. The portion where the first gas passes is the gas flow path 511 in FIG. 5A, and the first gas is supplied to the back surface of the unit cell 3 via the first through-holes 9 of the conductive substrate 2. At this time, since the surface flow paths 10 are formed on the surface of the conductive substrate 2 as shown in FIG. 3, the first gas is supplied to the second through-holes 8 of the porous support layer 4 via the surface flow paths 10, thereby enabling to reduce the loss of the power generation area. The first gas supplied to the second through-holes 8 is supplied to the first electrode layer 5 and is further supplied to the interface between the first electrode layer 5 and the electrolyte layer 6, with the first electrode layer 5 formed in a porous structure.

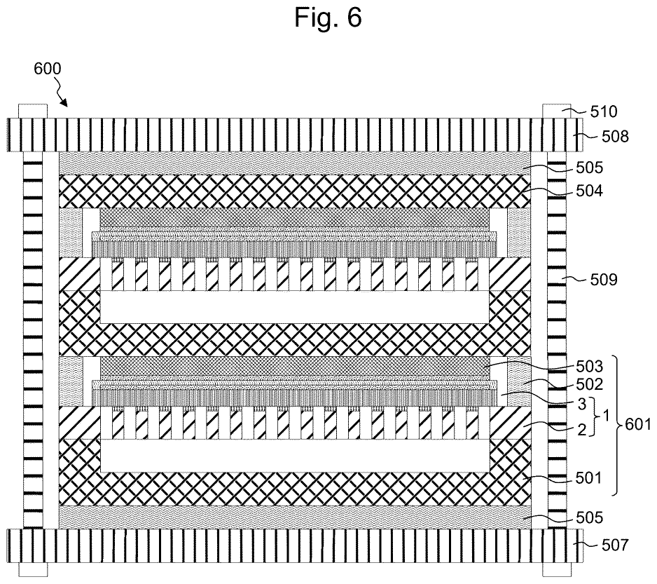

The first gas that has reached the first gas outlet 501b of the separator flows toward the first gas outlet 505b of the lower gasket and is discharged to the outside of the fuel cell stack 500 via the bottom jig 507. Further, as shown in FIG. 6 described later, when a plurality of fuel cells 1 is stacked, the first gas flows upward while passing through the first gas inlet 2a of the conductive substrate and then the first gas inlet 502a of the cell portion gasket.

The second gas supplied through the second gas inlet 506c of the upper gasket flows into the second gas inlet 504c of the upper electrode plate 504. The second gas further moves toward the second gas inlet 502c of the cell portion gasket. Since the second gas inlet 502c of the cell portion gasket has a cut-out, the second gas moves toward the second gas outlet 502d of the cell portion gasket while passing over the unit cell 3 on the conductive substrate 2. The current collector 503 is on the unit cell 3, but when the current collector 503 has a gas-permeable structure such as a mesh structure, the second gas can be supplied to the second electrode layer 7 on the surface of the unit cell 3. Further, with the second electrode layer 7 formed in a porous structure, the second gas can be supplied up to an interface between the second electrode layer 7 and the electrolyte layer 6.

The second gas that has reached the second gas outlet 501d of the cell portion gasket moves, via the second gas outlet 504d of the upper electrode plate 504, toward the second gas outlet 506d of the upper gasket and is discharged to the outside of the fuel cell stack 500 via the top jig 508.

### Embodiment 2

FIG. 6 is a cross-sectional view showing an example of the structure of a fuel cell stack 600 according to Embodiment 2 of the present invention. The fuel cell stack 600 includes a unit stack 601, the upper electrode plate 504, the lower gasket 505, the upper gasket 506, the bottom jig 507, the top jig 508, the supports 509, and the fastening members 510. The unit stack 601 refers to an area composed of the fuel cell 1, the separator 501, the cell portion gasket 502, and the current collector 503. The configuration of the fuel cell 1 is the same as that of Embodiment 1.

The difference from Embodiment 1 is that the unit stack 601 is structured to be stacked in the vertical direction. This allows two unit cells 3 to be connected in series, thereby increasing the output voltage of the entire stack. Further, with the unit stack 601 repeatedly stacked, it is also possible to form three or more unit cells in series, thereby also increasing the output voltage of the entire stack according to the number of stacks. In such a case of a plurality of stacks as well, the loss of the power generation area can be suppressed by providing the surface flow paths 10 on the surface of the conductive substrate 2 in the same manner as in Embodiment 1.

### Embodiment 3

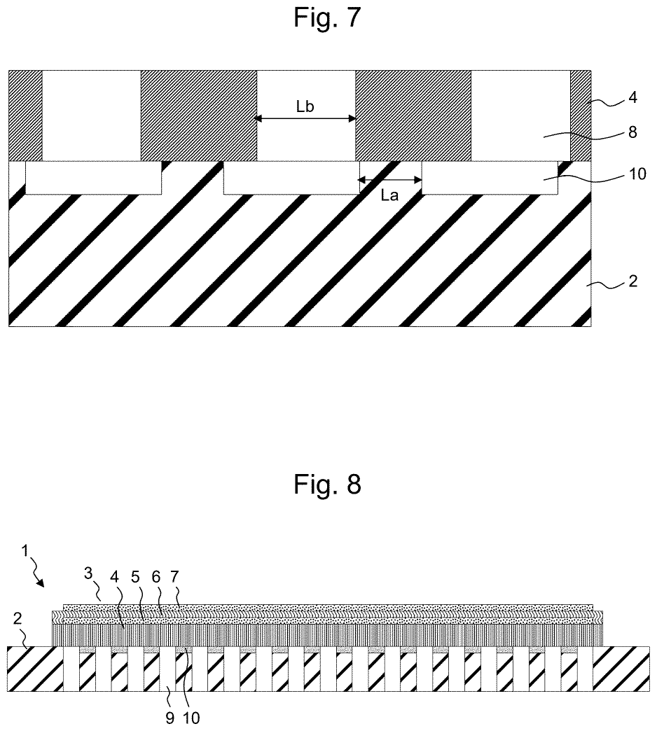

FIG. 7 is a cross-sectional view showing an example of the structure of the fuel cell 1 according to Embodiment 3 of the present invention. In Embodiment 1, as in FIG. 3B, the X-Y coordinate positions of the second through-holes 8 of the porous support layer 4 and the surface flow paths 10 of the conductive substrate 2 coincide with each other. However, the second through-hole 8 and the surface flow path 10 have a dimension of around several hundred nanometers, and it may be difficult to align their positions and repeat lengths.

Thus, in Embodiment 3, as shown in FIG. 7, the width of a projection of the surface flow path 10 (La in the drawing) is made shorter than the width of the second through-hole 8 of the porous support layer 4 (Lb in the drawing), thereby preventing the second through-hole 8 from being completely sealed. This can prevent the loss of the power generation area. The other configurations are the same as those of Embodiment 1.

### Embodiment 4

FIG. 8 is a cross-sectional view showing an example of the structure of the fuel cell 1 according to Embodiment 4 of the present invention. The surface flow path 10 of the conductive substrate 2 is not necessarily rectangular and can be, for example, an aggregate of fine particles. The other configurations are the same as those of Embodiment 1.

Since voids between the particles are also all filled with gas, when the gas is consumed during the power generating operation, the concentration decreases near the interface between the first electrode layer 5 and the electrolyte layer 6. As a result, the gas is diffused within the surface flow paths 10 by following the voids between the particles. At this time, when the diameter of each fine particle is smaller than the width of the second through-hole 8, the second through-hole 8 is not sealed, and the loss of the power generation area can be prevented. For the material of the fine particles, for example, nickel may be used. The surface flow path 10 composed of an aggregate of fine particles can be formed using a method in which an organic solvent or the like is made into a paste, applied to the surface of the conductive substrate 2, and fired.

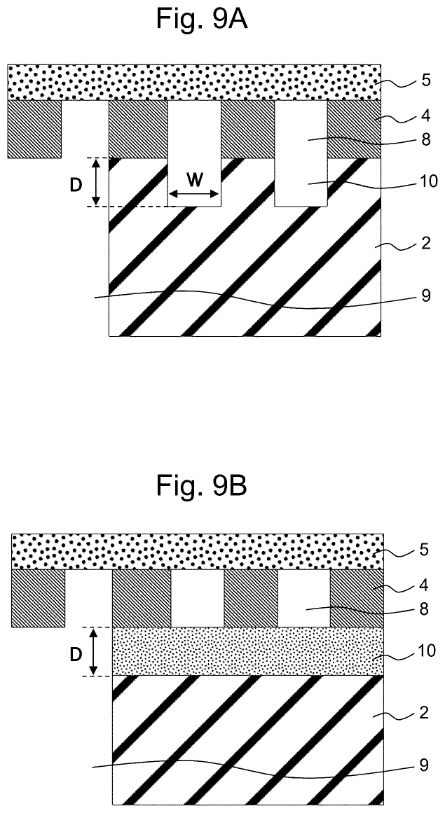

FIG. 9A and FIG. 9B are views for explaining the definition of the depth of the surface flow path 10 in the present invention. FIG. 9A is a case where the surface of the conductive substrate 2 is machined and FIG. 9B is a case where a layer of an aggregate of fine particles or the like is used as the surface flow path 10 as in Embodiment 4. In either method, a length corresponding to D denoted by an arrow in the drawing, i.e., a length from a portion closest to the porous support layer 4 to the bottom surface of the porous support layer 4 in the area of the conductive substrate 2 where there is no gas flow path in the X-and Y-directions is defined as the depth of the surface flow path 10.

When the surface flow path 10 is extremely shallow, a gas supply shortage occurs. However, in order to deepen the surface flow path 10, adverse effects arise in that machining is difficult in the case of FIG. 9A, the layers need to be formed multiple times in the case of FIG. 9B, and the like. It is therefore desirable to minimize the depth of the surface flow path 10 as much as possible. For example, ranges of 1.0 to 3.5 micrometers in the case of FIGS. 9A and 1.5 to 12 micrometers in the case of FIG. 9B are desirable. In the case of FIG. 9A, the machining difficulty is determined mainly based on an aspect ratio D/W of the depth D and width W, and this aspect ratio is desirably in a range of 3-100. The depth of the surface flow path 10 required in the case of FIG. 9B depends on the porosity of the aggregate of particulates or the like (the ratio of the volume of only the voids to the total volume including the voids). A lower porosity affects the gas diffusion, whereas a higher porosity affects the parasitic electrical resistance, and therefore, the porosity is desirably in a range of 30 to 70%.

### Embodiment 5

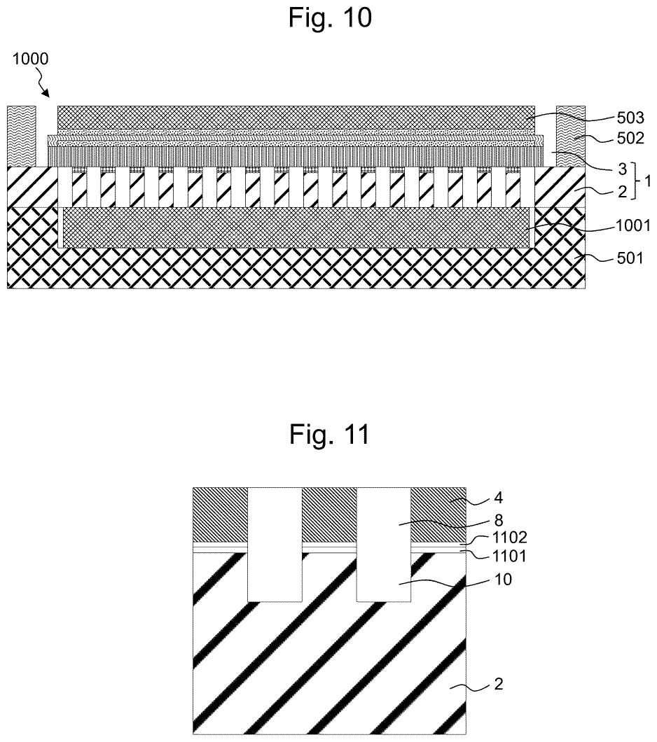

FIG. 10 is a cross-sectional view showing an example of the structure of a fuel cell 1000 according to Embodiment 5 of the present invention. In Embodiment 5, a current collector 1001 is inserted between the conductive substrate 2 and the separator 501. When current is extracted in the X-direction or the Y-direction in the separator 501, there are three current paths in the X-and Y-directions: (a) the X-and Y-directions within the conductive substrate 2, (b) the X-and Y-directions within the separator 501, and (c) the X-and Y-directions in the current collector 1001. This can reduce the parasitic resistance of the current path, as compared to a case in which there are only two current paths without the current collector 1001.

When a plurality of unit cells 3 is connected in series as in FIG. 6, the electrons move in the Z-direction from the conductive substrate 2 toward a lower layer while passing through the current collector 1001 and the separator 501. In this case, the fuel cell stack is assembled by stacking the fuel cells 1000 as a unit stack and fastening them together as shown in FIG. 6. The other configurations are the same as those of Embodiment 2.

In a case where there is no current collector 1001, when the fuel cells 1000 are connected in series as in FIG. 6, the current flows through the conductive substrate 2, a side wall of the separator 501, and a bottom surface of the separator 501 in this order. Since this current path is longer as compared to the case where there is the current collector 1001, the parasitic resistance increases as compared to the case where there is the current collector 1001. The increase in the parasitic resistance becomes more noticeable as the separator 501 is made thinner, which hinders downsizing of the fuel cell 1000. With the current collector 1001 arranged, such parasitic resistance can be suppressed.

As with the current collector 503, the current collector 1001 in a mesh structure is used so as not to prevent gas diffusion. The material used is nickel or the like, but when the first gas is an oxidant gas, material with high oxidation resistance, such as silver, is desirable.

In the stack structure of the fuel cell 1000, since current is extracted from an outer periphery of a metal substrate for the uppermost and lowermost layers of the stack, it is desirable to thicken the metal substrate according to the amount of current. Intermediate layers do not need to be thicken when there is a current collector.

### Embodiment 6

FIG. 11 is a cross-sectional view showing an example of the structure of the fuel cell 1 according to Embodiment 6 of the present invention. In the present embodiment, a precious metal layer 1101 is disposed on the front surface of the conductive substrate 2, and a precious metal layer 1102 is disposed on the back surface of the porous support layer 4. The other configurations are the same as those of Embodiment 1.

When the first gas is an oxidant gas, the conductive substrate 2 and the porous support layer 4 could be oxidized, resulting an increase in the contact resistance with the porous support layer 4. In a case where the first gas is a fuel gas as well, when water vapor is generated by the power generating operation, the conductive substrate 2 and the porous support layer 4 could be oxidized. Therefore, by forming the precious metal layers on both surfaces of the conductive substrate 2 and the porous support layer 4 contacting with each other, the increase in the contact resistance can be prevented. In FIG. 11, the precious metal layer 1101 is formed only on the projection of the surface flow path 10, but may also be formed on the inner side walls and bottom portion of the surface flow path 10. Further, when the porous support layer 4 is an insulating material, the through-hole inner wiring 11 shown in FIG. 4 may also serve as the precious metal layer 1102.

### Embodiment 7

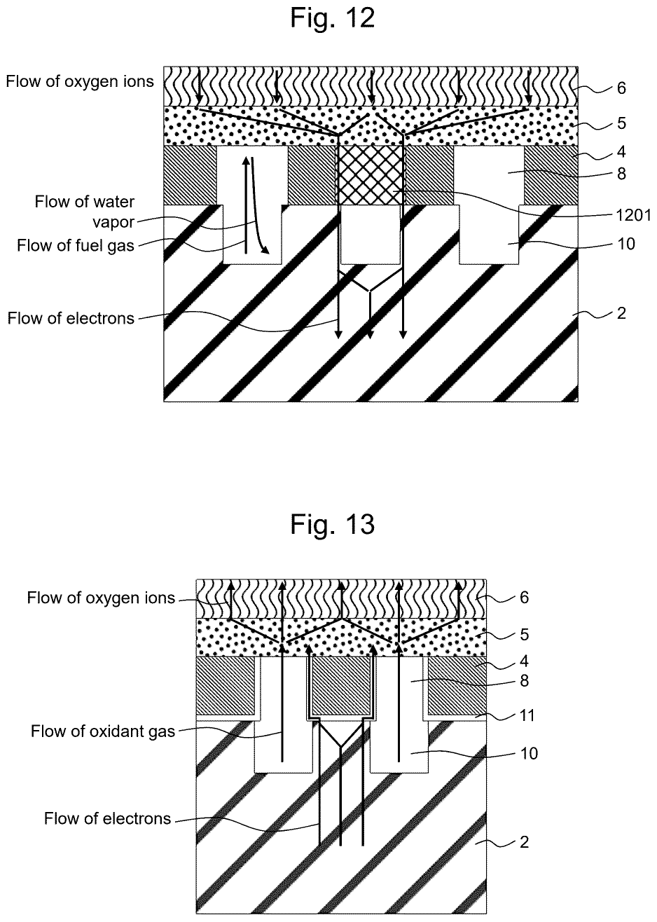

FIG. 12 is a cross-sectional view showing an example of the structure of the fuel cell 1 according to Embodiment 7 of the present invention. In Embodiment 1, when the porous support layer 4 is an insulating material, the through-hole inner wiring 11 is provided on the inner wall of the second through-hole 8 to achieve the electrical connection between the front and back of the fuel cell 1. In contrast, in the present embodiment, with a through electrode 1201 provided in part of the second through-holes 8, the electrical connection between the front and back is achieved. The other configurations are the same as those of Embodiment 1.

The through electrode 1201 can be formed by selectively disposing, for example, nickel or copper in part of the second through-holes 8 using a photolithographic technology. Although the parasitic resistance corresponding to the interval between the through electrodes 1201 occurs in the first electrode layer 5, it is also possible to reduce the power loss due to the parasitic resistance to, for example, 1% or lower.

In the second through-hole 8 provided with the through electrode 1201, the gas flow path is closed, which leads to the loss of the power generation area. The area loss can be suppressed by thinning out the through electrodes 1201, but it is undesirable to thin out the through electrodes 1201 since the moving distance of the electrons in the X-and Y-directions in the first electrode layer 5 increases, thereby increasing the power loss. In this case, the increase in the power loss can be prevented by, for example, increasing the film thickness of the first electrode layer 5.

### Embodiment 8

FIG. 13 is a cross-sectional view showing an example of the structure of the fuel cell 1 according to Embodiment 8 of the present invention. In the present embodiment, for the first electrode layer 5, material having both electron conductivity and ion conductivity is used. This allows the ionized gas to move in the X- and Y-directions in the first electrode layer 5. For example, since silver has both electron conductivity and oxygen ion conductivity, with the first electrode layer 5 formed of silver, ionized oxygen can move in the X- and Y-directions. When the electrolyte layer 6 is a hydrogen ion conductor, with the first electrode layer 5 formed of material having both electron conductivity and hydrogen ion conductivity, the ionized gas can move in the X- and Y-directions in the same manner. The other configurations are the same as those of Embodiment 1.

### Embodiment 9

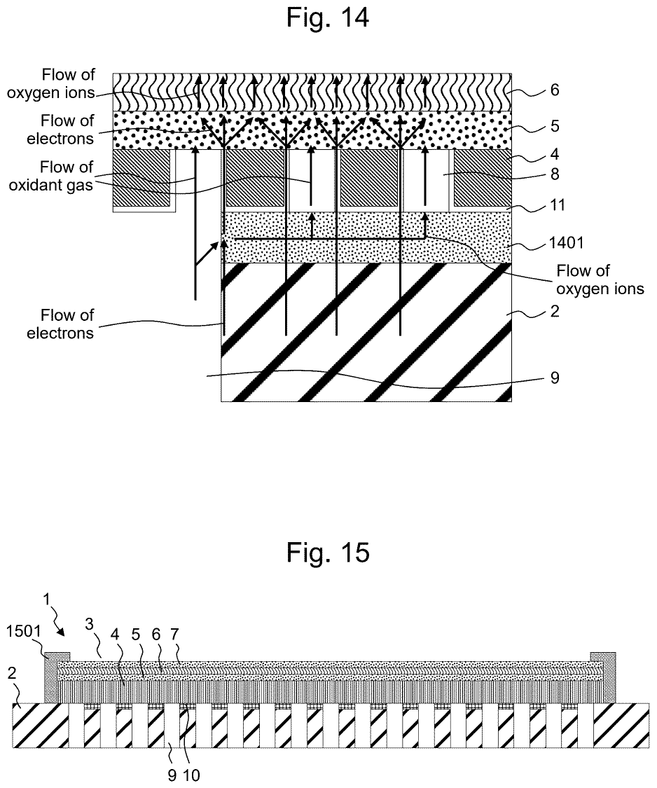

FIG. 14 is a cross-sectional view showing an example of the structure of the fuel cell 1 according to Embodiment 9 of the present invention. In the present embodiment, a surface ion flow path 1401 is provided on the surface of the conductive substrate 2. The other configurations are the same as those of Embodiment 1.

With the use of material having both electron conductivity and ion conductivity for the material of the surface ion flow path 1401, supply of the electrons to the first electrode layer 5 and supply of the oxidant gas to each second through-hole 8 are both achieved. Since movement with an ionized state is also possible in a solid, the surface ion flow path 1401 is not necessarily required to be gas-permeable. Further, for the material of the first electrode layer 5 as well, material having both electron conductivity and ion conductivity as in Embodiment 8 may be used.

### Embodiment 10

FIG. 15 is a cross-sectional view showing an example of the structure of the fuel cell 1 according to Embodiment 10 of the present invention. In the present embodiment, a sealing material 1501 is provided along the outer periphery of the unit cell 3. The other configurations are the same as those of Embodiment 1.

In Embodiment 1, since the sealing material 1501 is not provided, in order to prevent gas leakage, i.e., mixing of the fuel gas and the oxidant gas, the first electrode layer 5 in a porous structure is not present on the outer periphery of the unit cell 3, and the electrolyte layer 6 is provided on the porous support layer 4 only on the outer periphery. In contrast, in the present embodiment, the sealing material 1501 prevents gas leakage at the outer periphery of the unit cell 3, which allows the first electrode layer 5 to be provided over the entire surface. As a result, the film thickness of the electrolyte layer 6 can be reduced as compared to Embodiment 1. This is because in Embodiment 1, the electrolyte layer 6 is provided on the porous support layer 4 to prevent gas leakage at the outer periphery, which thus requires the film thickness sufficient to seal the second through-holes 8 of the porous support layer 4. In the present embodiment, the second through-holes 8 can be sealed by the first electrode layer 5 also at the outer periphery, and the voids on the surface due to the porous structure of the first electrode layer 5 only need to be sealed. The voids due to the porous structure of the first electrode layer 5 can be controlled by a film forming technique, and can also be made, for example, 1/10 or smaller of the second through-hole 8. Therefore, the film thickness can be made thinner as compared to Embodiment 1 that requires forming of the electrolyte layer 6 on the second through-holes 8.

### Embodiment 11

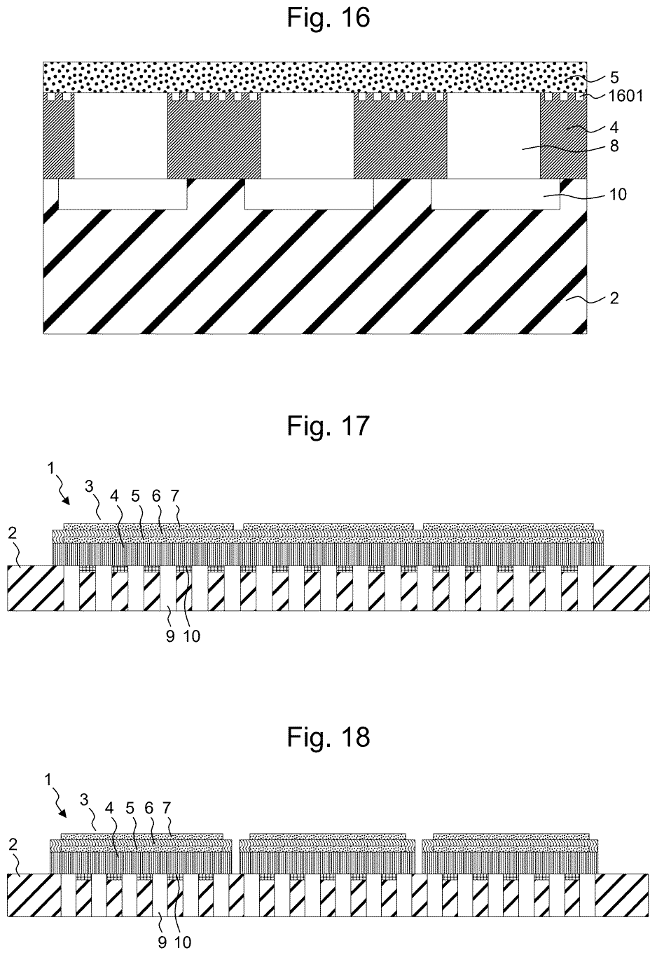

FIG. 16 is a cross-sectional view showing an example of the structure of the fuel cell 1 according to Embodiment 11 of the present invention. In the present embodiment, in addition to the surface flow paths 10 of the conductive substrate 2, surface flow paths 1601 are also added on the surface of the porous support layer 4. This allows the gas to be supplied to the first electrode layer 5 in a state of being further diffused in the X-and Y-directions, as compared to the case where the surface flow paths are provided only on the conductive substrate 2. The other configurations are the same as those of Embodiment 1.

### Embodiment 12

FIG. 17 is a cross-sectional view showing an example of the structure of the fuel cell 1 according to Embodiment 12 of the present invention. In the present embodiment, the second electrode layer 7 is made into a plurality of segments and disposed on the single fuel cell 1. As a result, for example, when a manufacturing defect occurs, without disposing the current collector 503 only in the portion that has become defective in the stack manufacturing, the defective portion is electrically isolated so as to be able to prevent the partial defect from affecting the entire stack.

### Embodiment 13

FIG. 18 is a cross-sectional view showing an example of the structure of the fuel cell 1 according to Embodiment 13 of the present invention. In the present embodiment, the unit cell 3 is made into a plurality of segments and disposed on one conductive substrate 2. In the case of Embodiment 12, when a defective portion is removed, the portion does not contribute to the power generation, resulting in a substantial area loss, but in the present embodiment, by replacing each unit cell 3, the area loss due to the defect can be prevented. In general, it can be said that as the area increases, the defective rate increases. When the defective rate is high during manufacturing over a large area across the entire conductive substrate 2, application of the present embodiment can prevent a cost increase associated with the disposal of defective products. Further, by dividing the unit cell 3, the risk of breakage due to the thermal stress can also be suppressed as compared to a case where the area is large.

It should be noted that the gas leakage between a plurality of unit cells 3 disposed need to be prevented by not providing the surface flow path 10 on the conductive substrate 2. Alternatively, as in Embodiment 10, the sealing material 1501 may be provided along the outer periphery of each unit cell 3.

### Modifications of the Present Invention

The present invention includes various modifications without being limited to the aforementioned embodiments. For example, the aforementioned embodiments have been described in detail for easier understanding of the present invention, and the present invention is not necessarily limited to those including all the described configurations. Further, it is possible to replace part of the configuration of one embodiment with the configuration of another embodiment, and it is also possible to add the configuration of one embodiment to the configuration of another embodiment. Furthermore, for part of the configuration of each embodiment, addition of other configurations, deletion, and replacement are possible.

### REFERENCE SIGNS LIST

1 Fuel cell
2 Conductive substrate
3 Unit cell
4 Porous support layer
5 First electrode layer
6 Electrolyte layer
7 Second electrode layer
8 Second through-hole
9 First through-hole
10 Surface flow path

1. A fuel cell comprising:
a conductive substrate having a first through-hole;
a porous support layer disposed on the conductive substrate and having a second through-hole; and
a fuel cell disposed on the porous support layer,
wherein
the fuel cell comprises:
a first electrode layer;
an electrolyte layer disposed on the first electrode layer; and
a second electrode layer disposed on the electrolyte layer,
the conductive substrate is disposed so as to contact the porous support layer at a location of the conductive substrate where the first through-hole is not formed, and
a structure allowing gas to flow in a direction orthogonal to an extending direction the first through-hole is formed at an interface between the conductive substrate and the porous support layer at the location.

2. The fuel cell according to claim 1, wherein
the structure is formed by arranging, within a plane orthogonal to the extending direction, a plurality of projections projecting from a surface of the conductive substrate, and
a width of each projection is smaller than a width of the second through-hole.

3. The fuel cell according to claim 1, wherein the structure is composed of an aggregate of fine particles.

4. The fuel cell according to claim 1, wherein
the porous support layer is composed of an aluminum oxide, and
metal is formed on an inner side of at least one second through-hole.

5. The fuel cell according to claim 1, wherein a diameter of the second through-hole is 300 nm or smaller.

6. The fuel cell according to claim 1, wherein a thickness of the electrolyte layer is 1 μm or smaller.

7. The fuel cell according to claim 1, further comprising:
a separator that supports the conductive substrate, the separator including a flow path for supplying gas to the conductive substrate;
a first current collector disposed on the second electrode layer; and
a second current collector disposed between the conductive substrate and the separator.

8. The fuel cell according to claim 1, further comprising a precious metal layer at an interface where the structure and the porous support layer contact with each other.

9. The fuel cell according to claim 1, wherein the first electrode layer has both electron conductivity and ion conductivity.

10. The fuel cell according to claim 1, further comprising an ion flow path between the conductive substrate and the porous support layer, the ion flow path having both electron conductivity and ion conductivity.

11. The fuel cell according to claim 1, further comprising a sealing material for sealing an outer periphery of the fuel cell.

12. The fuel cell according to claim 1, wherein a structure allowing gas to flow in the direction orthogonal to the extending direction of the first through-hole is formed at an interface between the porous support layer and the first electrode layer.

13. The fuel cell according to claim 1, wherein the second electrode layer of the fuel cell that is a unit is made into two or more segments.

14. The fuel cell according to claim 1, wherein
two or more pairs of the porous support layer and the fuel cell are disposed on the conductive substrate that is a unit, and
in voids between the pairs on a surface of the conductive substrate, the structure is not formed or a sealing material is disposed to seal the voids, thereby preventing gas from being discharged from the conductive substrate.

15. The fuel cell according to claim 1, wherein
a depth of the structure in the extending direction is 1 μm or greater, and
a thermal expansion coefficient of the conductive substrate is 10×10⁻⁶/K or smaller.
